(19) United States
(12) Patent Application Publication
(10) Pub. No.: US 2013/0240768 A1
(43) Pub. Date: Sep. 19, 2013

(54) High Density Polyethylene Gate Valve

(71) Applicants: Benjamin Benson, Bend, OR (US); Jason MacKenzie, Sisters, OR (US); Brandon Holmen, Sisters, OR (US)

(72) Inventors: Benjamin Benson, Bend, OR (US); Jason MacKenzie, Sisters, OR (US); Brandon Holmen, Sisters, OR (US)

(73) Assignee: ENERGYNEERING SOLUTIONS, INC., Bend, OR (US)

(21) Appl. No.: 13/606,048

(22) Filed: Sep. 7, 2012

Related U.S. Application Data
(60) Provisional application No. 61/534,541, filed on Sep. 14, 2011.

(51) Int. Cl. F16K 3/24; F16K 51/00; F16K 31/50

(52) U.S. Cl. CPC F16K 3/24; F16K 31/50; F16K 51/00
USPC 251/273; 251/329; 251/368

(57) ABSTRACT

A gate or gate-type valve is used as a flow regulating device specifically for use in saturated gaseous, high particulate, high temperature, and low pressure environments such as in landfill gas wellfields and similar environments where particulate and water gathering can obstruct the operation of a typical gate valve. The valve has a T-shaped body with a fluid flow tube and a transverse plunger tube. A plunger threads into the plunger tube to define a fluid-tight seal between the plunger and the plunger tube and has a distal end that opens and closes the fluid flow tube as the plunger is rotated between open and closed positions.

### FIELD OF INVENTION

This invention relates to apparatus and methods for regulating fluid flow, and more particularly to a self sealing gate valve especially adapted and designed for use in challenging environments.

### BACKGROUND

Landfills are often prolific contributors of green house gases, particularly methane (CH4) which according to the EPA is a greenhouse gas approximately 21 times more potent than carbon dioxide (C02), emissions. A common method of waste disposal and treatment, landfills produce these gases, among others, from the anaerobic digestion by microbes of organic matter. These gases, typically composed of mostly methane and carbon dioxide, may be collected and methane in particular may be utilized, with contemporary technology, to generate electricity by combustion, fuel industrial boilers, or be converted to pipeline quality High-BTU gas. In utilizing the methane from the landfill, greenhouse gas emissions are greatly reduced.

Landfills frequently have gas extraction systems to capture landfill gases. Gases are typically drawn out of a landfill with a low pressure vacuum via a wellfield collection system. The wellfield typically consists of multiple gas extraction wells that extend deep beneath the surface of the landfill to pull methane from a location near the bottom of the landfill. Each extraction well extends up to the surface of the landfill and there the extraction wells are manifolded together so that vacuum can be pulled with one centralized blower or compressor.

It is critical to regulate the vacuum draw on the landfill wellfield and flow of gas through the system and it will be appreciated that wellfield gas recovery and extraction systems employ numerous flow regulating devices, including a variety of valves. Regulating the vacuum or draw on the field regulates, to a degree, the type and rate of decomposition. Too much draw may pull oxygen into the wellfield enabling aerobic decomposition and causing underground fires thus requiring shutdown of the wellfield resulting in unrestricted release of greenhouse gases into the atmosphere. Too small of a draw will increase gas diffusion into surrounding soil and eventual release of methane into the atmosphere. Typically each extraction well utilizes a valve at the head of the well to adjust the vacuum pulled on the well. After monitoring the extraction well's gas flow and composition, an operator may adjust this valve to optimize gas recovery or limit oxygen pull into the landfill.

Landfill gas monitoring and recovery is referred to as a wet gas industry because the gases created in landfills are typically 100 percent saturated because water is produced throughout the wellfield in addition to oxygen, nitrogen, methane and carbon dioxide. The wet gas, the possibility of particulates, and low pressures associated with these systems present some significant challenges for gas flow regulating devices, particularly the valves used in the systems. Many existing valves can be damaged by the corrosive environment, and particulates in the gas often cause problems with proper sealing at the valve seat.

There is a need therefore for improved apparatus for regulating gas flow through landfill gas wellfield recovery systems, and in particular, valves that avoid the problems of know systems.

### SUMMARY OF INVENTION

The subject invention is a gate or gate-type valve designed for use as a flow regulating device specifically for use in saturated gaseous, high particulate, high temperature, and low pressure environments such as in landfill gas wellfields and similar environments where particulate and water gathering can obstruct the operation of a typical gate valve.

### BRIEF DESCRIPTION OF THE DRAWINGS

The invention will be better understood and its numerous objects and advantages will be apparent by reference to the following detailed description of the invention when taken in conjunction with the following drawings.

FIG. 1 is a side elevation view of a first illustrated embodiment of a valve assembly according to the present invention, showing the valve plunger and housing in an assembled condition.

FIG. 2 is an end elevation view of the valve assembly shown in FIG. 1.

FIG. 3 is an exploded view of the valve assembly shown in FIG. 1 illustrating the components of the assembly.

FIG. 4 is a cross sectional view taken along the line 4-4 of FIG. 1, illustrating the valve assembly of the present invention with the plunger in the open position.

FIG. 5 is a cross sectional view similar to the view of FIG. 4 except showing the plunger in the closed position.

FIG. 6 is a cross sectional view taken along the line 6-6 of FIG. 1, illustrating the valve assembly of the present invention with the plunger in the open position.

FIG. 7 is a cross sectional view similar to the view of FIG. 6 except showing the plunger in the closed position.

FIG. 8 is a cross sectional view taken along the line 8-8 of FIG. 5.

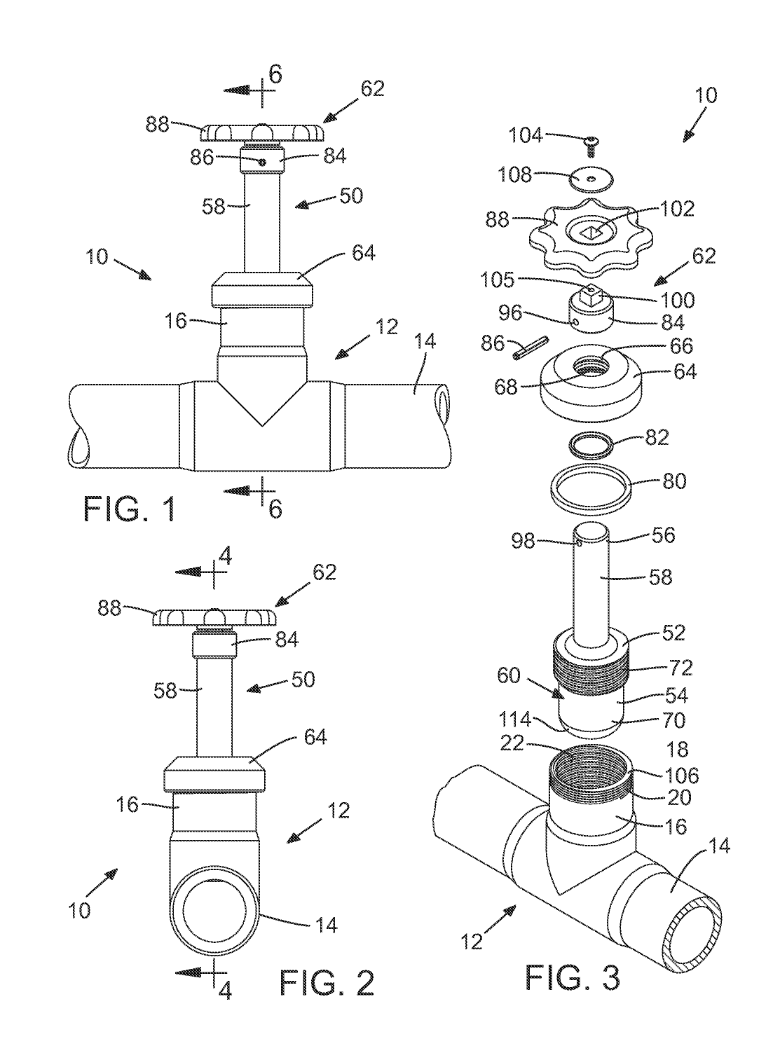

### DETAILED DESCRIPTION OF ILLUSTRATED EMBODIMENTS

The valve assembly 10 according to the present invention is a gate valve that is defined by a valve body or housing 12 and a plunger assembly 50. The plunger assembly 50 is in turn comprised of a plunger body 52 and a valve handle assembly 62. The body 12 is defined generally by a T-shaped fitting having a linear length of tubing 14 that is plumbed inline in a wellfield gas line and a plunger assembly tube 16 that extends transverse to the linear tubing 14. The housing 12 is preferably a one-piece unit that is fabricated from high density polyethylene (HDPE). The housing defines open conduits through the interior of the housing: the housing is plumbed in-line with appropriate connector fittings and the gas flow path extends through the linear tubing 14 and the plunger assembly fits into the plunger assembly tube 16. As detailed below, the interior of the housing includes plunger seating structures to facilitate complete closure of the valve. It will be appreciated that the valve assembly 10 may be fabricated in any size appropriate for any particular installation—the nominal size of the tubing used for valve assembly 10 is sized to fit the tubing into which the valve assembly will be installed.

The outermost end 18 of plunger assembly tube 16 has external threads 20 and internal threads 22, the purpose of which is detailed below.

With reference to FIG. 3, plunger assembly 50 comprises a plunger body 52 and a valve handle assembly 62. Plunger body 52 is preferably defined by a one-piece elongate member that includes generally a distal end 54 and a proximal end 56. An upper shaft portion 58 is adjacent the proximal end 56 and a lower shaft portion 60 that has an enlarged diameter relative to the upper shaft portion 58 is at the distal end 54. Valve handle assembly 62 is the components shown in FIG. 3 that are directly and removably attached to the end of upper shaft portion 58 at distal end 54 and allows an operator to axially rotate the plunger assembly 50 to open and close the valve assembly 10. Valve handle assembly 62 comprises the following components: an internally threaded bonnet 64, a first O-ring 80, a second O-ring 82, a cap 84, a spring pin 86, and a handle 86. The bonnet 64 has a central opening 66, and as seen in FIG. 3, the bonnet 64 is assembled with the plunger body 52 with upper shaft portion 58 extending through opening 66 of bonnet 64. The opening 66 is sized to conform closely to upper shaft portion 58 and to form a seal against it and that seal is enhanced by second O-ring 82, which resides in a circumferential groove in opening 66 so that the O-ring encircles upper shaft 58 and defines a seal between the bonnet 64 and the upper shaft 58. The internal threads of bonnet 64 are identified with reference number 68.

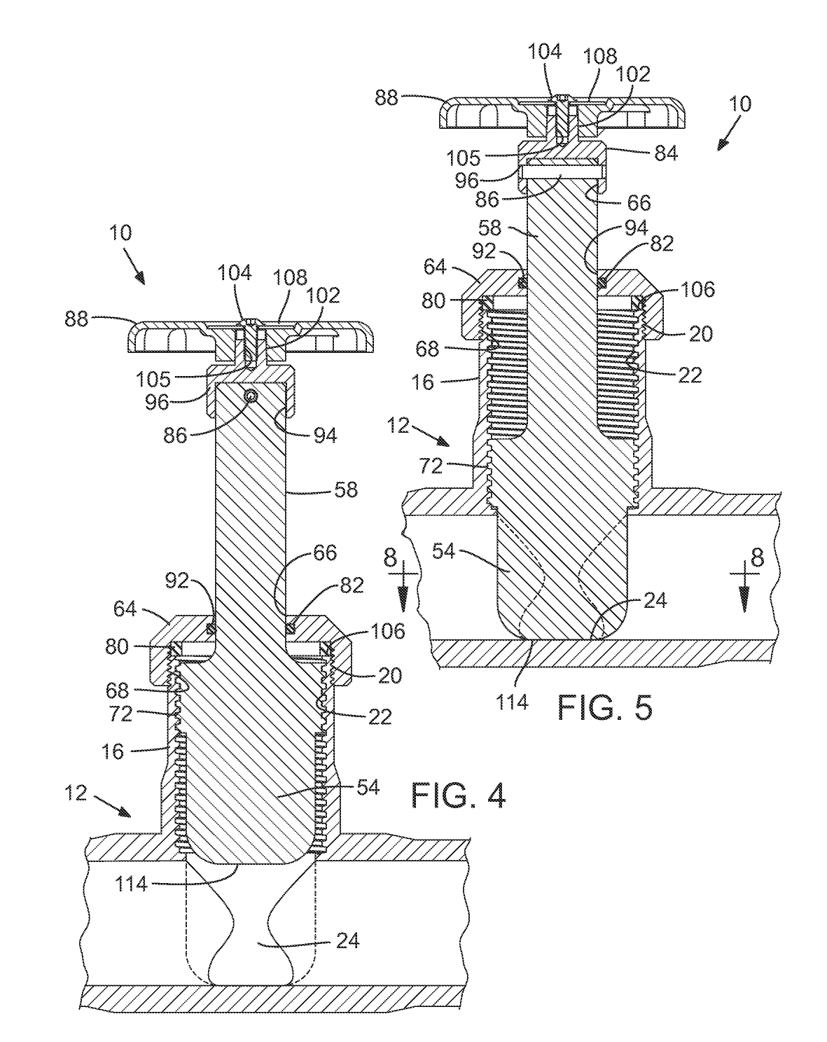

With reference now to FIGS. 4 and 5 the assembled handle assembly 62 will be detailed. The first O-ring 80 is installed in a circumferential seat 90 in bonnet 64 and the second O-ring 82 is installed in a circumferential groove 92 in bonnet opening 66. With the first and second O-rings thus installed, the shaft 58 is inserted through opening 66. Cap 84, which has an internal cylindrical blind opening 94 is installed over the end of shaft 58 and spring pin 86 is inserted through an opening 96 in cap 84 and into an aligned opening 98 in shaft 58 to thereby secure the cap to the shaft. The “upper” end of cap 84 has a square protrusion 100 that is sized to fit into a cooperatively shaped opening 102 in handle 88 and the handle is thus attached to the cap by inserting the protrusion 100 into the opening 102. The handle is secured to the assembly with a screw 104 that threads into a threaded opening 105 in cap 84; a washer 106 is used to retain the handle on the cap.

The lower shaft portion 60 of plunger body 52 defines a sealing portion identified generally with reference number 70 and a threaded portion 72. The sealing portion 70 includes at the distal end 114 of the plunger body a semi-hemispherically shaped bottom portion. That is, moving from the proximal to the distal ends, the vertical sidewalls of the sealing portion 70 transition to a smoothly radiused circumferential area that transitions to a generally flattened distal end 114.

Valve 10 is assembled by attaching plunger assembly 50 with housing 12. Specifically, and as best illustrated in the cross sectional images of FIGS. 4 and 5, distal end 54 of plunger body 52 is inserted into the opening of plunger assembly tube 16 and threaded portion 72 of the plunger body 52 is threaded into internal threads 22 of the plunger assembly tube 16. As the plunger body is threaded into the plunger assembly tube, the sealing portion 70 of lower shaft portion 60 moves inwardly into the body 12. Because the body is one-piece, the sealing portion 70 rotates as the body 52 is rotated to thread the body into the tube. At the point where the treaded portion 72 of the plunger body 52 are fully threaded into the internal threads 22 the bonnet 64 may be threaded onto the plunger assembly tube—that is, the internal threads 68 of the bonnet 64 may be threaded onto the external threads 20 of the assembly tube 16 and the bonnet is tightened in place to secure the plunger body 52 to the housing 12. As the bonnet 64 is tightened onto the external threads 20 of the assembly tube 16, first O-ring 80 is compressed between the upper circumferential rim 106 that is defined by the outer end 18 of assembly tube 16 and the seat 90 in the bonnet, thereby creating a leak-free seal between the interior of the valve 10 and the exterior of the valve. Moreover, it will be appreciated that the bonnet prevents disassembly of the plunger body 52 from the housing 12. That is, with the bonnet installed and tightened as in FIG. 4, the plunger may not be threaded outwardly far enough to separate the plunger from the housing.

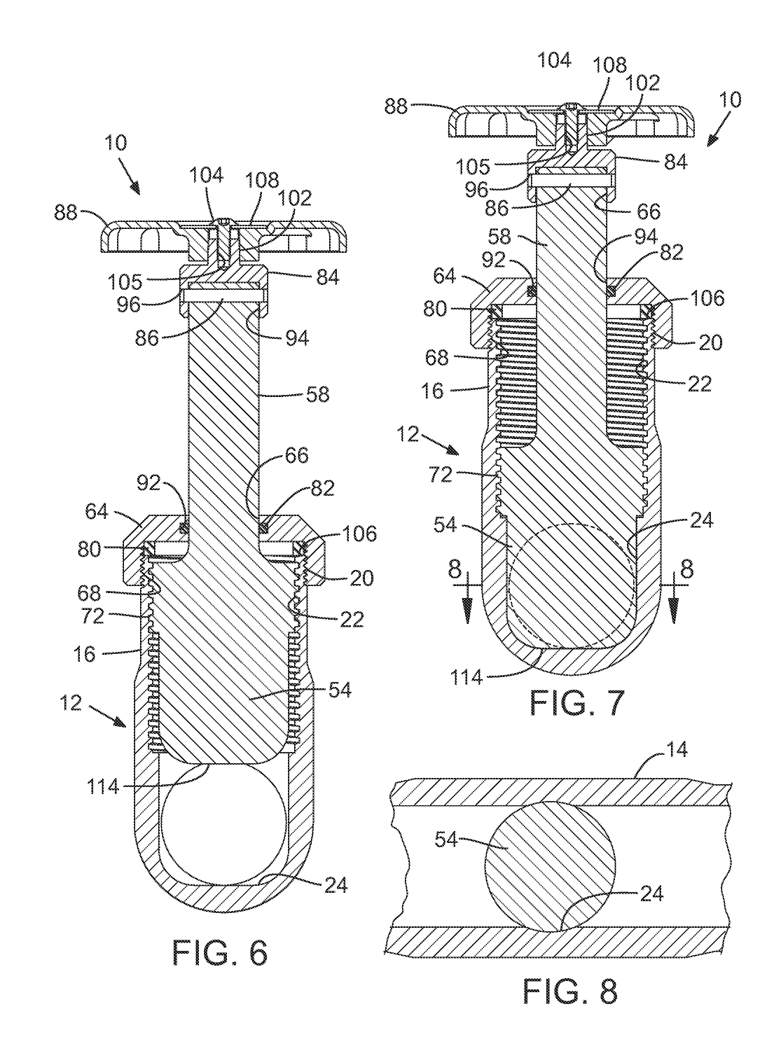

The valve 10 is shown in the open position in FIGS. 4 and 6, and in the closed position is FIGS. 5 and 7. From these figures it may be seen that the interior portion of the linear run of tubing 14 of housing 12 defines a valve seat 24 that is configured complimentary to the shape of sealing portion 70 of plunger body 52. That is, the valve seat 24 is semi-hemispherically shaped to correspond to the semi-hemispherical shape of the distal end 114 of sealing portion 70. More specifically, as shown in the drawings, the distal end 114 is defined by the substantially vertical sidewall of the sealing portion 70, which transition to a radiused circumferential edge and a generally flattened bottom portion at distal end 114.

It will be appreciated that as handle 88 is rotated axially to move plunger body 52 inwardly into housing 12 (with the threaded portion 72 of body 52 rotating in threads 22 of plunger assembly tube 16), the sealing portion 70 is driven into valve seat 24. When the distal end 114 makes contact with the valve seat 24 and is tightened against the valve seat by continued rotation of handle 88, the valve 10 is in the closed position, which of course closes the gas pathway through the valve. It will be appreciated that the valve assembly 10 is opened by axially rotating handle 88 in the opposite direction to move distal end 114 out of its sealing position against valve seat 24.

With reference to FIGS. 6, 7 and 8, it may be seen that the valve seat 24 is defined essentially by a cylindrical bore that is cut into valve housing 12, wherein the axis of the bore is coaxial with the axis extending through plunger assembly tube 16 and the bore extends into the tubing 14 immediately below the tube 16 to define the seat 24. The threaded interconnection between the threaded portion 72 of body 52 rotating in threads 22 of plunger assembly tube 16 is a very close tolerance and defines an effective gas-tight seal between the passageway through tube 14 (through which gas flows) and the upper portion of the valve plunger assembly 50—i.e., that portion of the valve plunger assembly outward of threaded portion 72. The threaded interconnection of the bonnet 64 with external threads 20 also define a secondary or backup gas-tight seal, combined with O-ring 82, which as noted previously, seals against shaft 58.

The plunger assembly 50 may be used for regulating or limiting flow through the valve assembly by varying the position of the distal end 54 to thereby vary the size of the gas flow path through the valve.

The valve assembly 10 is a self sealing valve and defines two separate valve closing components. The first valve sealing component is defined by the gas flow opening and closing function of the distal end 54 and valve seat 24. This first valve sealing component is used to open, close, and regulate the flow of gas through valve assembly 10. The second valve sealing component comprises a primary and a secondary sealing functionality. The first is defined by threads 72 from the plunger body 52, which seal off the valve and operational handle from the gas flow section of the valve assembly 10. The second is defined by the bonnet 64, which as noted previously seals against upper shaft portion 58.

The plunger body 52 is a one piece system fabricated from HDPE. This may be contrasted with typical gate valves that utilize two or three piece plunger or gate systems. The one piece design does not allow vibration on the plunger during operation as with a typical two or three piece gate valve that can vibrate from the flow when not in the fully closed or fully open position.

Utilizing this one piece plunger design, valve assembly 10 has more rigidity when opening/closing the valve. This one piece plunger design is milled out of HDPE but is not limited to this material.

Other typical valves on the market have a separate female threaded plunger with a male threaded bonnet. In contrast, the valve assembly 10 utilizes a male threaded plunger and a female threaded bonnet.

The valve assembly 10 also utilizes a different style of sealing design in the throat as compared to a typical gate valve. Thus, typical gate valves seal using planar surfaces of the plunger against a complimentary shaped lip inside the valve body; this typically results in obstruction of flow and build-up of debris. The valve assembly 10 described and illustrated herein utilizes a semi-hemispherical shaped plunger that is received in a complimentary shaped seat at the bottom of the housing body; this ensures a solid seal around the plunger without obstructing flow. As shown in FIG. 8, the surface of the valve plunger that is presented to fluid flow in the linear tubing 14 is always a curved surface.

The valve assembly 10 is manufactured out of HDPE material (excluding handle 62 and the screws, pins used to attach the handle to the upper shaft 58). Because the entire valve is HDPE the valve may be fused into place permanently utilizing heat transfer welding techniques rather than bolted, threaded, or glued into place as with other gate valves.

The bonnet 64 also acts as a back up seal to threads 72 should the threads 72 wear and start to leak.

In one preferred embodiment, the housing body 12 utilizes a 2″ HDPE SDR-9 molded Tee. This tee is then custom milled inside the throat to receive the one piece threaded plunger.

The one piece threaded plunger rotates in a cylindrical motion throughout the entire travel area of the valve; with typical gate valves, the plunger does not travel in the horizontal direction, instead it only travels vertically while the plunger shaft rotates horizontally.

With typical valves, if the plunger travels linearly the plunger only comes in contact with the seat of the valve body when the valve is closed; if the plunger is a rotating plunger it is always in contact with the seat. The sealing portions of valve assembly 10—specifically, sealing portion 70, only comes in contact with the valve seat 24 when the valve is in the closed position, even though sealing portion 70 of course rotates axially as the handle 62 is rotated.

It will be appreciated that all of the components of the plunger assembly 50, and the assembly itself, may be replaced in the field if the unit is damaged or leaking. In addition to the embodiments described above that illustrate the invention, those of skill in the art will appreciate that various substitutions and alterations may be made without departing from the scope of the invention. As a first example, the shape of the distal end 114 of the plunger body 52, and the corresponding cooperative shape of the valve seat 24 may be varied. The shape shown in the drawings is described as being semi-hemispherical in geometry. The end 114 could just as well be a complete hemisphere, in which case the valve seat 24 would be cooperatively shaped as a hemisphere. As a second example, the bonnet 64 described above threads onto the external threads 20 of the plunger assembly tube 16. The bonnet could just as well have external threads that thread into internal threads in the tube 16.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. A valve, comprising:
a valve plunger having a distal end comprising a sealing portion, a handle at a proximal end and a threaded portion between the distal and proximal ends;
a valve body having a tubular linear extension and a plunger assembly tube transverse to the linear extension, said plunger tube assembly having internal threads;
wherein, the threaded portion of the valve plunger is threaded into the internal threads of the plunger assembly tube to define a fluid-tight seal between the valve plunger and the valve body so that fluid in the tubular linear extension is prevented from escaping from the tubular linear extension.

2. The valve according to claim 1 in which the valve plunger is movable between an open position in which a fluid flow pathway is defined through the tubular linear extension and a closed position in which the valve plunger closes the fluid pathway through the tubular linear extension.

3. The valve according to claim 2 in which the sealing portion of the valve plunger includes a body portion having a substantially cylindrical cross sectional configuration and wherein a cooperatively shaped valve seat is defined in the tubular linear extension for receiving the sealing portion of the valve plunger in the closed position to define a fluid-tight seal between the valve plunger and the tubular linear extension.

4. The valve according to claim 3 in which the sealing portion of the valve plunger further comprises a flattened distal end portion and a circumferential radiused wall portion between said flattened distal end portion and said body portion having a substantially cylindrical cross sectional configuration.

5. The valve according to claim 1 in which the plunger assembly tube has external threads and including a valve bonnet threaded onto the external threads, said bonnet having an opening through which a shaft of the valve plunger extends.

6. The gate valve according to claim 5 where when the valve plunger is in the open position the threaded of the valve plunger is always threaded into the internal threads of the plunger assembly tube to define a first fluid-tight seal between the valve plunger and the valve, and including a second fluid-tight seal between the valve plunger and the valve body.

7. The valve according to claim 6 wherein the second fluid-tight seal between the valve plunger and the valve body is defined by the bonnet, a first O-ring compressed between the bonnet and the valve body, and a second O-ring retained in the bonnet and compressed against the shaft of the plunger.

8. The valve according to claim 5 wherein the bonnet prevents removal of the valve plunger from the valve body.

9. The valve according to claim 1 fabricated entirely of HDPE.

10. A valve, comprising:
a one-piece valve plunger shaft having a sealing element at a distal end of said shaft, a handle at a proximal end of said shaft and a threaded portion between the distal and proximal ends;
a valve body having an internally threaded plunger assembly tube for receiving the valve plunger and a fluid pathway tube extending transverse to the plunger assembly tube, said plunger assembly tube opening into said fluid pathway tube;
wherein, the threaded portion of the valve plunger is threaded into the internal threads of the plunger assembly tube and thereby defines a fluid-tight seal between the valve plunger and the valve body, and the valve plunger is rotatably movable between an open position in which the fluid pathway tube is open and a closed position in which the fluid pathway tube is closed.

11. The valve according to claim 10 in which the threaded portion of the valve plunger seals against the internal threads of the plunger assembly tube when the plunger is in both the open and closed positions.

12. The valve according to claim 11 wherein a distal end of the valve plunger defines a sealing portion and wherein the fluid pathway tube further defines a valve seat, the sealing portion of the valve plunger having a complimentary shape to the valve seat so that when the valve plunger is in the closed position the sealing portion defines a fluid-tight closure of the fluid pathway tube.

13. A valve, comprising:
a T-shaped valve body comprising a linear section and a plunger tube section extending transverse to the linear section and opening into the linear section;
a valve plunger means for creating and maintaining a fluid-tight seal in the plunger tube section, said valve plunger means movable in the plunger tube section for opening and closing a fluid flow path through the linear section.

14. The valve according to claim 13 wherein the valve plunger means is movable between a first position in which the fluid flow path is open and a second position in which the fluid flow path is closed, and wherein the valve plunger means maintains the fluid-tight seal in the plunger tube section when the valve plunger means is in both the first and second positions.

15. The valve according to claim 14 wherein the valve plunger means further comprises an elongate shaft having a distal end comprising a sealing portion that is operable to open and close the fluid flow path, a handle at a proximal end and a threaded portion between the distal and proximal ends.

16. The valve according to claim 15 wherein the plunger tube section includes internal threads and the threaded portion of the elongate shaft threads into the internal threads of the plunger tube section.

17. The valve according to claim 16 further comprising valve seat means in the linear section, said valve seat means having a configuration complimentary to the configuration of the sealing portion of the valve plunger means so that when said valve plunger the second position said sealing portion is received in said valve seat means to close the flow path.

18. The valve according to claim 17 in which the valve plunger means is rotatably movable between the first and second positions and wherein the distal end of said elongate shaft is rotatable in said valve seat means.

19. The valve according to claim 19 wherein said valve plunger means is fabricated in one piece.

20. The valve according to claim 19 wherein said valve plunger means is fabricated from HDPE.
